(19) United States
(12) Patent Application Publication
(10) Pub. No.: US 2026/0308341 A1
(43) Pub. Date: Oct. 8, 2026

(54) COMPOSITIONS, USES, AND METHODS

(71) Applicant: INNOSPEC LIMITED, Ellesmere Port (GB)

(72) Inventor: Matthew Robert GILES, Ellesmere Port (GB)

(21) Appl. No.: 19/476,280

(22) PCT Filed: Apr. 26, 2024
(86) PCT No.: PCT/GB2024/051125

§ 371 Date: Oct. 17, 2025

(30) Foreign Application Priority Data
Apr. 28, 2023 (GB) 2306301.9

(51) Int. Cl. C08J 3/28; C08F 12/08; C08F 20/06; C08F 20/14; C08F 20/38; C08K 5/17

(52) U.S. Cl. CPC C08J 3/28; C08F 12/08; C08F 20/06; C08F 20/14; C08F 20/38; C08K 5/175

(57) ABSTRACT

The use of a salt of iron and ethylenediamine disuccinic acid as a free radical initiator in the free radical polymerisation reaction of one or more monomers.

The present invention relates to compositions useful in the preparation of polymers. The invention further relates to free radical polymerisation reactions, especially photoinitiated free radical polymerisation reactions. In particular the invention relates to free radical polymerisation reactions carried out in an aqueous environment.

Many common polymers are prepared via free radical polymerisation reactions. In such reactions polymerisation is usually induced using an initiator compound, typically in the presence of heat and/or light.

Many free radical initiators require thermal activation and may need to be heated, for example to temperatures in excess of 70° C.

Many free radical initiators of the prior art are only soluble in non-aqueous systems.

However, for environmental reasons, it is desirable to carry out reactions in aqueous systems and without heating if possible.

It is an aim of the present invention to provide improved free radical polymerisation reactions.

According to a first aspect of the present invention there is provided the use of a salt of iron and ethylenediamine disuccinic acid as a free radical initiator in the free radical polymerisation reaction of one or more monomers.

The present invention relates to the use of a salt of iron and ethylenediamine disuccinic acid.

By a salt of iron and ethylenediamine disuccinic acid we mean to refer to any compound which includes iron cations and ethylenediamine disuccinic acid anions. In such salts iron may be present as a divalent or trivalent cation and ethylenediamine disuccinic acid may be present as an ion having at least one carboxylate anion.

Ethylenediamine disuccinic acid has the structure shown in formula (I):

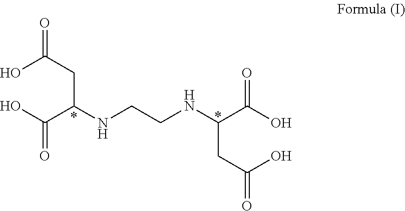 [SMILES: O=C(O)CC(NCCNC(CC(=O)O)C(=O)O)C(=O)O]

Ethylenediamine disuccinic acid (EDDS) includes two stereogenic centres and there are three possible stereoisomers. A particularly preferred configuration is [S,S]-ethylenediamine disuccinic acid which is readily biodegradable.

In this specification the abbreviation “EDDS” is used to denote the structure shown in formula (I) and the same structure in which a number of the hydrogen atoms of the COOH moieties have been replaced. Thus EDDS may also be used to refer to succinate salts in which 1, 2, 3 or 4 of the acid groups have been neutralised or partially neutralised.

The invention relates to a salt of iron and ethylenediamine disuccinic acid. Iron is preferably present as the trivalent cation. In addition to iron (III) cations and ethylenediamine disuccinic acid anions, other cations and/or anions may form part of the salt.

Preferably, to form the salt of EDDS used in the present invention, a trivalent iron salt is reacted with ethylenediamine disuccinic acid or a salt thereof. The iron salt and EDDS compound may suitably be reacted in a ratio of from 20:1 to 1:20, preferably from 10:1 to 1:10, more preferably from 5:1 to 1:5, suitably from 2:1 to 1:2. In especially preferred embodiments a trivalent salt of iron and ethylenediamine disuccinic acid or a salt thereof are reacted in an approximate 1:1 molar ratio.

In preferred embodiments the salt of iron and ethylenediamine disuccinic acid may be represented by the formula FeXEDDS wherein X is a hydrogen, metal, ammonium or substituted ammonium cation.

Preferably X is selected from hydrogen, NH₄⁺ or an akali metal cation. Most preferably X is selected from a hydrogen, lithium, potassium or sodium cation. Preferably X is selected from a hydrogen or sodium cation. In especially preferred embodiments X is Nat.

For the avoidance of doubt, in the formula FeXEDDS, iron is present as Fe³⁺ and EDDS is present as the tetra-anion (EDDS⁴⁻).

The skilled person will appreciate that since the compounds of formula FeXEDDS are suitably prepared from the reaction of an iron salt and EDDS acid or a salt thereof, other ions will be present in the reaction mixture obtained, for example phosphate, halide, nitrate, sulfate. This reaction mixture may be used in the methods and uses of the present invention, without purification. However embodiments in which the compound of formula FeXEDDS is isolated and/or purified are also within the scope of the invention.

The salt of iron and ethylenediamine disuccinic acid may be prepared by any suitable means. The selection of a suitable method for preparing the salt will be within the competence of the person skilled in the art. Suitable methods are described, for example, in U.S. Pat. No. 5,717,123, EP1153914, US2002/032343 and U.S. Pat. No. 5,679,817.

The first aspect of the present invention relates to the use of a salt of iron and ethylenediamine disuccinic acid as a free radical initiator. By this we mean that the salt is able to initiate a free radical polymerisation reaction. Suitably in order to function as a free radical initiator in a polymerisation reaction the salt must be activated. Activation of the salt suitably involves the formation of a free radical species. Activation is suitably achieved by application of actinic radiation.

By actinic radiation we mean to refer to radiation such as UV and/or visible light which can be absorbed by a molecule and thereby cause a photochemical reaction.

According to a second aspect of the present invention there is provided a method of preparing a polymer, the method comprising contacting one or more monomers with a radical species derived from a salt of iron and ethylenediamine disuccinic acid.

The salt of iron and ethylenediamine disuccinic acid is preferably as described in relation to the first aspect.

Further preferred features of the first and second aspects will now be described.

In the method of second aspect the salt of iron and ethylenediamine disuccinic acid is contacted with one or more monomers.

By one or more monomers we mean to refer to one type or more than one type of monomer.

In some embodiments the second aspect of the present invention provides a method of preparing a homopolymer in which all monomers are identical. In some embodiments the second aspect of the present invention may involve preparing a copolymer in which two or more different monomers are reacted.

In the method of the second aspect a radical species derived from a salt of iron and ethylenediamine disuccinic acid is contacted with one or more monomers.

The method suitably involves generating a radical species from a salt of iron and ethylenediamine disuccinic acid. The free radical species may be formed in an initial pre-treatment step in which the radical is formed and then subsequently contacted with one or more monomers. In some preferred embodiments of the method of the second aspect, the salt of iron and ethylenediamine disuccinic acid is contacted with one or more monomers and the radical species derived from a salt of iron and ethylenediamine disuccinic acid is generated in situ.

In embodiments in which a copolymer is formed, the method may involve contacting a first monomer with a radical species derived from a salt of iron and ethylenediamine disuccinic acid and then contacting the resultant mixture with a second monomer and optionally further monomers.

In embodiments in which a copolymer is formed, the method may involve admixing a first monomer, a second monomer and optionally further monomers together and then contacting the mixture of monomers with a radical species derived from a salt of iron and ethylenediamine disuccinic acid.

The second aspect of the present invention preferably involves contacting one or more monomers with a salt of iron and ethylenediamine disuccinic acid and activating said salt to form a free radical species. Activation of the salt may be achieved by the application of actinic radiation.

In preferred embodiments activation of the salt of iron and ethylenediamine disuccinic acid is achieved by exposure to actinic radiation. In some embodiments the reaction mixture may be heated or cooled during activation. In preferred embodiments activation is preferably carried out at ambient temperature.

Preferably activation of the salt of iron and ethylenediamine disuccinic acid is achieved by exposure to actinic radiation having a wavelength of 100 to 400 nm, preferably 260 to 390 nm.

One preferred source of actinic radiation is natural light.

In some embodiments the method of the second aspect of the present invention involves the steps of:
(a) preparing a composition comprising one or more monomers and a salt of iron and ethylenediamine disuccinic acid; and
(b) exposing the composition provided in step (a) to actinic radiation.

In some embodiments step (a) may be carried out in dark conditions, for example in a darkened or covered vessel.

The composition provided in step (a) may consist essentially of one or more monomers and the salt of iron and ethylenediamine disuccinic acid. In some embodiments the composition provided in step (a) may comprise one or more further components.

The salt of iron and ethylenediamine disuccinic acid may be provided in any suitable form. The presence of further ions or neutral molecules within the salt is within the scope of the invention. The salt may suitably be provided in a form that includes other components that result from the manufacture thereof, such as unreacted starting materials and byproducts. In some embodiments the salt may be provided in isolated or purified form.

The salt of iron and ethylenediamine disuccinic acid is suitably provided as a powder or an aqueous solution.

In some embodiments the composition provided in step (a) may comprise one or more solvents and/or one or move additives.

The selection of suitable solvents and/or additives will depend on the nature of the one or more monomers. The selection of suitable monomers, solvents and additives will be within the competence of the person skilled in the art.

In preferred embodiments the composition provided in step (a) comprises one or more solvents.

A particular advantage of the present invention is that polymerisation can be carried out in an aqueous environment.

Thus in some preferred embodiments the composition provided in step (a) comprises water and optionally one or more water-miscible solvents.

In some embodiments the composition provided in step (a) may be in the form of a suspension or an emulsion.

Step (b) of the method of the second aspect involves exposing the composition provided in step (a) to actinic radiation.

Suitably step (b) involves exposing the composition provided in step (a) to actinic radiation having a wavelength of 100 to 400 nm, preferably 260 to 390 nm.

Step (b) may involve allowing natural light to pass through the walls of a transparent vessel comprising the mixture prepared in step (a).

Step (b) may comprises shining actinic radiation (e.g. UV and/or visible light) onto the composition prepared in step (a). In some embodiments the actinic radiation may pass entirely through the composition prepared in step (a) while in some embodiments the actinic radiation may penetrate only a portion of the composition near the surface or surfaces exposed to the actinic radiation source. This will of course depend of the nature, shape and size of the vessel and the nature of the one or more monomers.

In some embodiments an artificial actinic radiation source such as a UV lamp of the desired wavelength may be shone through a sight glass on a reactor.

In some embodiments source of actinic radiation may be provided on an immersed probe within a reactor.

In preferred embodiments the composition in step (b) is agitated to ensure that different parts of the composition are exposed to actinic radiation.

In some embodiments step (a) may be carried out in a transparent vessel under exposure to natural or artificial actinic radiation. In such embodiments steps (a) and (b) are suitably carried out concurrently.

The second aspect of the present invention involves contacting one or more monomers with a radical species derived from a salt of iron and ethylenediamine disuccinic acid. In some embodiments the free radical species is before contacting it with one or more monomers.

The present inventors have found that the free radical species derived from a salt of iron and ethylenediamine disuccinic acid is stable and can be stored after generation for use later.

According to a third aspect of the present invention there is provided an activated free radical initiator comprising a salt of iron and ethylenediamine disuccinic acid.

The activated free radical initiator of the third aspect is suitably provided by exposing a salt of iron and ethylenediamine disuccinic acid to actinic radiation having a wavelength of 100 to 400 nm, preferably 260 to 390 nm.

After exposure to the actinic radiation the activated free radical initiator is suitably stored in a container which does not transmit UV or visible light having a wavelength of 260 to 390 nm.

According to a fourth aspect of the present invention there is provided a packaged free radical initiator comprising within a container an activated free radical initiator comprising a salt of iron and ethylenediamine disuccinic acid; wherein the container does not transmit UV or visible light having a wavelength of 260 to 390 nm.

By activated free radical initiator we mean to refer to a salt which has been exposed to actinic radiation, suitably having a wavelength of 100 to 400 nm, preferably 260 to 390 nm.

Advantageously the activated free radical initiator has been found to be still effective at initiating polymerisation reactions more than 4 hours after exposure to actinic radiation.

Suitably the activated free radical initiator is still able to initiate a polymerisation reaction more than 12 hours after exposure to actinic radiation, for example more than 24 hours.

Suitably the activated free radical initiator is still able to initiate a polymerisation reaction after more than 3 days after exposure to actinic radiation, for example after more than 7 days, more than 10 days or more than 14 days.

That the free radical initiator remains active for a significant period after exposure to actinic radiation represents a significant advantage as it means that the end user of the material carrying out the polymerisation reaction does not need to provide the actinic radiation. It also means that a wider range of vessels can be used to carry out the polymerisation reaction.

In some embodiments the method of the second aspect may involve the steps of:
(i) providing a composition comprising a salt of iron and ethylenediamine disuccinic acid;
(ii) exposing the composition comprising the salt of iron and ethylenediamine disuccinic acid to actinic radiation to provide an activated free radical initiator composition;
(iii) optionally storing the activated free radical initiator composition provided in step (ii); and
(iv) contacting the activated free radical initiator composition with one or more monomers.

The composition provided in step (i) may consist essentially of the salt of iron and ethylenediamine disuccinic acid or it may comprise one or more diluents or carriers. Suitable diluents and carriers will be known to the person skilled in the art.

In step (ii) the composition comprising the salt of iron and ethylenediamine disuccinic acid is suitably exposed to actinic radiation having a wavelength of 100 to 400 nm, preferably 260 to 390 nm.

Step (iii) suitably involves storing the activated free radical initiator composition in a container which does not transmit UV or visible light having a wavelength of 260 to 390 nm.

In step (iii) the activated free radical initiator composition may be stored for at least 4 hours, for example at least 12 hours or at least 24 hours.

In some embodiments, the activated free radical initiator composition may be stored for up to a year, for example up to 3 months, up to 30 days or up to 15 days.

The method of the second aspect of the present invention may be used to prepare a wide range of polymers for use in many different applications.

The reaction may be carried out at any suitable temperature, for example from −30 to 150° C.

Varying the temperature may in some embodiments vary the composition of the polymer produced, for example, the degree of branching. In preferred embodiments reactions are carried out at ambient temperature.

Advantageously precursor compositions can be prepared comprising a mixture of monomers and initiators. These may conveniently be stored in conditions which avoid exposure to actinic radiation and hence activation of the initiator.

According to a fifth aspect of the present invention there is provided a polymer precursor composition comprising one or more monomers and a salt of iron and ethylenediamine disuccinic acid.

According to a sixth aspect of the present invention there is provided a packaged polymer precursor product comprising within a container a composition comprising one or more monomers and a salt of iron and ethylenediamine disuccinic acid; wherein the container does not transmit UV or visible light having a wavelength of 260 to 390 nm.

Preferably the container does not transmit UV or visible light having a wavelength of 100 to 400 nm.

Preferably the container does not transmit UV or visible light of any wavelength.

According to a seventh aspect of the present invention there is provided a polymer obtained by the free radical polymerisation of one or more monomers in a reaction initiated by a salt of iron and ethylenediamine disuccinic acid.

Preferred features of the fifth, sixth and seventh aspects of the invention are as defined in relation to the first, second, third and fourth aspects. Further preferred features of all aspects of the invention will now be described.

The present invention relates to the polymerisation of one or monomers.

Any suitable monomer may be polymerised according to the present invention. Monomers which can be polymerised using free radical polymerisation include an alkene functional group.

The present invention may be used to prepare a vast array of polymers including, for example, homopolymers, block copolymers, graft copolymers, terpolymers, brush polymers, gradient copolymers (i.e. in which monomer composition gradually changes from predominantly one species to predominantly the other), polymerisation of macromonomers, star (or star-shaped) polymers and dendrimeric polymers. The selection of suitable monomers and reaction conditions to form these types of polymer is within the competence of the person skilled in the art.

Suitable monomers may include one or more olefinic double bonds. The one or more monomers may be selected from any compound that can be polymerised by free radical polymerisation of the double bond. Suitable monomers for use in the present invention include oligomers and prepolymers, including copolymeric species that contain a double bond.

Examples of suitable monomers for use herein containing one polymerizable double bond include alkyl, hydroxyalkyl, cycloalkyl (which optionally interrupted by O) or amino acrylates, or alkyl, hydroxyalkyl, cycloalkyl (which optionally interrupted by O) or amino methacrylates, for example methyl, ethyl, butyl, 2-ethylhexyl or 2-hydroxyethyl acrylate, tetrahydrofurfuryl acrylate, isobornyl acrylate, methyl methacrylate, cyclohexyl methacrylate or ethyl methacrylate. Silicone acrylates are also advantageous. Other examples include acrylonitrile, acrylamide, methacrylamide, N-substituted (meth)acrylamides, vinyl esters such as vinyl acetate, vinyl ethers such as isobutyl vinyl ether, styrene, alkyl- and halostyrenes (e.g. α-methylstyrene), divinylbenzene, N-vinylpyrrolidone, vinyl chloride or vinylidene chloride.

Other suitable monomers include cyclic olefins; for example, cyclopentene, cyclohexene and norbornene; and cyclic ketene acetals, for example 4,7-dimethyl-2-methylene-1,3-dioxepane (DMMDO).

Examples of suitable monomers containing two or more double bonds include diacrylates of ethylene glycol, propylene glycol, neopentyl glycol, hexamethylene glycol or of bisphenol A, and 4,4′-bis(2-acryl-oyloxyethoxy)diphenylpropane, trimethylolpropane triacrylate, pentaerythritol triacrylate or tetraacrylate, vinyl acrylate, divinylbenzene, divinyl succinate, diallyl phthalate, triallyl phosphate, triallyl isocyanurate or tris(2-acryloylethyl) isocyanurate.

Examples of polyunsaturated compounds of relatively high molecular mass (oligomers) include acrylated epoxy resins, polyesters containing acrylate-, vinyl ether- or epoxy-groups, and also polyurethanes and polyethers. Further examples of unsaturated oligomers are unsaturated polyester resins, which are usually prepared from maleic acid, phthalic acid and one or more diols. In addition it is also possible to employ vinyl ether monomers and oligomers, and also maleate-terminated oligomers with polyester, polyurethane, polyether, polyvinyl ether and epoxy main chains. Of particular suitability are combinations of oligomers which carry vinyl ether groups and of polymers as described in WO 90/01512. However, copolymers of vinyl ether and maleic acid-functionalized monomers are also suitable. Unsaturated oligomers of this kind can also be referred to as prepolymers.

Suitable monomers for use herein include esters of ethylenically unsaturated carboxylic acids and polyols or polyepoxides, and polymers having ethylenically unsaturated groups in the chain or in side groups, for example unsaturated polyesters, polyamides and polyurethanes and copolymers thereof, alkyd resins, polybutadiene and butadiene copolymers, polyisoprene and isoprene copolymers, polymers and copolymers containing (meth)acrylic groups (e.g. (meth)acrylic esters) in side chains, and also mixtures of one or more such polymers.

Examples of ethylenically unsaturated carboxylic acids are acrylic acid, methacrylic acid, crotonic acid, itaconic acid, cinnamic acid, and unsaturated fatty acids such as linolenic acid or oleic acid. Acrylic and methacrylic acid are preferred.

Suitable polyols are aromatic and, in particular, aliphatic and cycloaliphatic polyols. Examples of aromatic polyols are hydroquinone, 4,4′-dihydroxydiphenyl, 2,2-di(4-hydroxyphenyl)-propane, and also novolaks and resols. Examples of polyepoxides are those based on the abovementioned polyols, especially the aromatic polyols, and epichlorohydrin. Other suitable polyols are polymers and copolymers containing hydroxyl groups in the polymer chain or in side groups, examples being polyvinyl alcohol and copolymers thereof, polyhydroxyalkyl methacrylates or copolymers thereof, or novolak resins. Further polyols which are suitable include oligoesters having hydroxyl end groups.

Examples of aliphatic and cycloaliphatic polyols include alkylenediols having preferably 2 to 12 carbon atoms, for example ethylene glycol, 1,2- or 1,3-propanediol, 1,2-, 1,3- or 1,4-butanediol, pentanediol, hexanediol, octanediol, dodecanediol, diethylene glycol, triethylene glcyol, polyethylene glycols having molecular weights of 200 to 5000, preferably from 200 to 1500, 1,3-cyclopentanediol, 1,2-, 1,3- or 1,4-cyclohexanediol, 1,4-dihydroxymethylcyclohexane, glycerol, tris-(β-hydroxyethyl)amine, trimethylolethane, trimethylolpropane, pentaerythritol, dipentaerythritol and sorbitol.

The polyols may be partially or completely esterified with one carboxylic acid or with different unsaturated carboxylic acids, and in partial esters the free hydroxyl groups may be modified, for example etherified or esterified with other carboxylic acids.

Examples of esters include: trimethylolpropane triacrylate, trimethylolethane triacrylate, trimethylolpropane trimeth-acrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripenta erythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate. sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 5000, preferably 200 to 1500, or mixtures thereof.

Further suitable monomers include amides of identical or different, unsaturated carboxylic acids with aromatic, cycloaliphatic and aliphatic polyamines having preferably 2 to 6, especially 2 to 4, amino groups. Examples of such polyamines are ethylenediamine, 1,2- or 1,3-propylenediamine, 1,2-, 1,3- or 1,4-butylenediamine, 1,5-pentylenediamine, 1,6 hexylenediamine, octylenediamine, dodecylenediamine, 1,4-diaminocyclohexane, isophoronediamine, phenylenediamine, bisphenylenediamine, di-[beta]-aminoethyl ether, diethylenetriamine, triethylenetetramine, di([beta]-aminoethoxy)- or di([beta]-aminopropoxy) ethane. Other suitable polyamines are polymers and copolymers, preferably with additional amino groups in the side chain, and oligoamides having amino end groups. Examples of such unsaturated amides include methylenebisacrylamide, 1,6-hexamethylenebisacrylamide, diethylenetriaminetrismethacrylamide, bis-(methacrylamidopropoxy) ethane, β-methacrylamidoethyl methacrylate and N-β-[(hydroxyethoxy)ethyl]acrylamide.

Suitable unsaturated polyesters and polyamides may be derived from maleic acid and from diols or diamines. Some of the maleic acid can be replaced by other dicarboxylic acids. They can be used together with ethylenically unsaturated comonomers, for example styrene. The polyesters and polyamides may also be derived from dicarboxylic acids and from ethylenically unsaturated diols or diamines, especially from those with relatively long chains of, for example 6 to 20 C atoms. Examples of polyurethanes include those composed of saturated or unsaturated diisocyanates and of unsaturated or, respectively, saturated diols.

Polybutadiene and polyisoprene and copolymers thereof are also useful herein. Examples of suitable comonomers include olefins, for example ethylene, propene, butene, hexene, octene, decene and dodecene, (meth)acrylates, acrylonitrile, styrene or vinyl chloride. Polymers with (meth)acrylate groups in the side chain are also useful. Examples include reaction products of epoxy resins based on novolaks with (meth)acrylic acid, and homo- or copolymers of vinyl alcohol or hydroxyalkyl derivatives thereof which are esterified with (meth)acrylic acid, or may be homo- and copolymers of (meth)acrylates which are esterified with hydroxyalkyl (meth)acrylates.

Suitable monomers for use herein include monoacrylates, diacrylates, polyacrylates, monomethacrylates, dimethacrylates, polymethacrylates, or combinations thereof. Exemplary monomers include methyl acrylate, methyl methacrylate, ethyl acrylate, ethyl methacrylate, isopropyl acrylate, isopropyl methacrylate, n-hexyl acrylate, 2-ethylhexyl acrylate, 2-ethylhexyl methacrylate, stearyl acrylate, allyl acrylate, glycerol acrylate, glycerol diacrylate, glycerol triacrylate, ethyleneglycol diacrylate, diethyleneglycol diacrylate, triethyleneglycol diacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexaacrylate, bis [1-(2-acryloxy)]-p-ethoxyphenyldimethylmethane, bis [1-(3-acryloxy-2-hydroxy)]-p-propoxyphenyldimethylmethane, and trishydroxyethyl-isocyanurate trimethylacrylate.

Further suitable monomers include bis-acrylates and bis-methacrylates of polyethylene glycol having an average molecular weight (Mn) of 200 to 500; copolymerisable mixtures of acrylated monomers such as those described in U.S. Pat. No. 4,652,274, acrylated monomers such as those described in U.S. Pat. No. 4,642,126; unsaturated amides, for example methylene bis-arylamide, methylene bis-methacrylamide, 1,6-hexamethylene bis-acrylamide, diethylene triamine tris-acrylamide, and beta-methacrylaminoethyl methacrylate; and vinyl monomers, for example as styrene, diallyl phthalate, divinyl succinate, divinyl adipate, and divinylphthalate.

Suitable monomers for use herein may be prepared, for example, by: transesterifying OH-functional resins, for example OH-functional polyesters, polyacrylates, polyurethanes, polyethers or epoxy resins, with alkyl esters of (meth)acrylic acid; esterifying such OH-functional resins with (meth)acrylic acid; reacting such OH-functional resins with isocyanate-functional (meth)acrylates; reacting acid-functional resins, for example polyesters, polyacrylates, polyurethanes with epoxy-functional (meth)acrylates; reacting epoxy-functional resins, for example polyesters, polyacrylates, epoxy resins with (meth)acrylic acid. These production methods will be known to the person skilled in the art.

Examples of prepolymers or oligomers suitable for use as monomers in the present invention include (meth)acryloyl-functional (meth)acrylic copolymers, polyurethane (meth)acrylates, polyester (meth)acrylates, unsaturated polyesters, polyether (meth)acrylates, silicone (meth)acrylates and epoxy resin (meth)acrylates having number-average molecular masses from, for example, 500 to 10,000, preferably 500 to 5,000.

Monomers suitable for use herein may include, in addition to a double bond, one or more further, identical or different functional groups. Examples of functional groups include hydroxyl, isocyanate (optionally blocked), N-methylol, N-methylolether, ester, carbamate, epoxy, amino (optionally blocked), acetoacetyl, alkoxysilyl and carboxyl groups. Examples include polyurethane resins with (meth)acryloyl groups and glycerol mono- and di-(meth)acrylate, trimethylol propane mono- and di(meth)acrylate or pentaerythritol tri (meth)-acrylate.

Polymers with (meth)acrylate groups in the side chain are suitable for use in the present invention. They may, for example, be reaction products of epoxy resins based on novolaks with (meth)acrylic acid, or may be homo- or copolymers of vinyl alcohol or hydroxyalkyl derivatives thereof which are esterified with (meth)acrylic acid, or may be homo- and copolymers of (meth)acrylates which are esterified with hydroxyalkyl (meth)acrylates.

Other suitable polymers with acrylate or methacrylate groups in the side chains include poly(amic acid ester) compounds described in EP 624826.

Suitable monomers for use herein include poly(ethylene glycol) methyl ether methacrylate and [2-(Methacryloyloxy)ethyl]dimethyl-(3-sulfopropyl) ammonium hydroxide (DMAPS).

The one or more monomers may suitably be selected from (meth)acrylates, alkenes, conjugated dienes, styrenes, alkyl and halo-styrenes (e.g. α-methylstyrene), divinylbenzene, acrolein, vinyl acetate, vinylpyrrolidone, vinylimidazole, maleic anhydride, fumaric anhydride, (meth)acrylic acid, (meth)acrylic acid derivatives, for example esters and amides, vinyl halides and vinylidene halides. Preferred are compounds having (meth)acryloyl, vinyl and/or maleinate groups. Especially preferred are (meth)acrylates.

A particular advantage of the present invention is that it can be used to synthesize polymers from methacrylic acid derived monomers.

Commonly acrylic acid derived monomers are used rather than methacrylic acid derived monomers in ultraviolet light (UV) and electron beam (EB) cured coatings due to faster cure speeds. Because methacrylate radicals are more stable than acrylate radicals they propagate more slowly. However polymers constructed from methacrylic acid derived monomers may have some advantages compared with those obtained from acrylic acid derived monomers, including higher glass transition (Tg) temperatures, improved impact resistance, and better weathering.

Preferably the one or more monomers for use in the present invention are selected from acrylates, methacrylates and styrene derivatives.

Preferably the one or more monomers for use in the present invention are selected from alkyl methacrylate (especially methyl methacrylate), styrene, maleic anhydride, decene, sodium acrylate, poly(ethylene glycol) methacrylate, vinyl pyrrolidone, acrylamide, alkyl acrylates (especially methyl methacrylate), diallyl dimethyl ammonium chloride, diethylene glycol dimethacrylate, PDMS vinyl terminated methacryloyloxyethyltrimethylammonium chloride, methacrylamidopropyltrimethylammonium chloride, acryloyloxyethyltrimethylammonium chloride, dimethyldiallylammonium chloride, 1,3-bis(N,N,N-trimethylammonium)-2-propylmethacrylate dichloride, 1,3-bis(N,N,N-trimethyl ammonium)-2-propylacrylate dichloride, sodium acrylate, sodium 2-acrylamido-2-methylpropane sulfonate, sodium vinyl sulfonate, sodium methacrylate, 4-vinyl benzylsulfonate, 4-isopropenyl-benzoate, vinyl phosphonate, acrylamide, methacrylamide, N,N-dimethylacrylamide, vinyl pyrolidonone, t-octyl acrylamide, acrylic acid, t-butyl aminoethyl methacrylate, hydroxy propyl methacrylate, N-tert-butylacrylamide, acrylic acid, 2-(diethylamino)ethyl methacrylate, 2-(dimethylamino)ethyl acrylate, (3-acrylamidopropyl)trimethylammonium chloride, 2-(methacryloyloxy)ethyl] trimethyl ammonium chloride and 3-(trimethoxysilyl) propyl methacrylate.

More preferably the one or more monomers for use in the present invention are selected from styrene, alkyl methacrylate, 2-(methacryloyloxy)ethyl dimethyl-(3-sulfopropyl) ammonium hydroxide, acrylic acid, poly(ethylene glycol) methacrylate, acrylamide, vinyl pyrrolidone and 2-acrylamido-2-methyl-1-propanesulfonic acid.

In the present invention mixtures of two or more monomers may be used in any relative ratios.

Suitable conditions for carrying out the polymerisation reactions of the present invention will depend on the nature of the one or more monomers.

The salt of iron and ethylenediamine disuccinic acid may be used in a variety of polymerisation reactions including homogeneous polymerisation reactions, bulk polymerisation reactions, solution polymerisation, heterogeneous polymerisation reactions (slurry, suspension, microemulsion, nanoemulsion), and dispersion polymerisation reactions (oil in water, water in oil). Suitable conditions for carrying out such reactions will be known to the person skilled in the art.

Suitable ratios of the initiator salt of iron and ethylenediamine disuccinic acid to the one or more monomers used will depend on the nature of the monomers, the reaction conditions and the degree of polymerisation.

Varying the ratio of the initiator salt to monomer may allow the degree of polymerisation to be controlled with a high degree of accuracy.

A particular advantage of the present invention is that high molecular weight polymers can be prepared quickly and reliably.

The salt of iron and ethylenediamine disuccinic acid is provided in an amount of from 0.001 to 100 wt % based on the total weight of the one or more monomers.

Preferably the salt of iron and ethylenediamine disuccinic acid is provided in an amount of from 0.001 to 40 wt %, preferably 0.002 to 20 wt %, more preferably 0.005 to 10 wt %, suitably 0.025 to 5 wt %, preferably 0.05 to 2 wt % based on the total weight of the one or more monomers.

The ratio of the salt of iron and ethylenediamine disuccinic acid to the one or more monomers may be optimised for the particular monomers used. Advantageously high yields (greater than 80% or greater than 90%) can be achieved when the salt is included in an amount of less than 5 wt %, suitably less than 2 wt % or even less than 1 wt % based on the total weight of the one or more monomers.

Advantageously present invention may be used to prepare polymers having a number average molecular weight in excess of 50,000. For example the present invention may provide a polymer having a number average molecular weight of more than 100,000; suitably more than 200,000; preferably more than 400,000, for example more than 600,000. In some embodiments the present invention may provide a polymer having a number average molecular weight of more than 700,000; suitably more than 800,000; for example more than 1,000,000.

The molecular weight of a polymer can be determined using a number of analytical techniques. These include osmotic pressure, light scattering, viscometry and gel permeation chromatography (GPC) (also called size exclusion chromatography (SEC)).

Preferably molecular weights defined herein are measured by size exclusion chromatography (SEC).

The present invention may also be useful in the synthesis of lower molecular weight polymers, for example polymers having a having a number average molecular weight of less than 50,000, for example less than 30,000, less than 10,000 or less than 5,000. In some embodiments the present invention can used to prepare oligomers via free radical polymerisation.

In embodiments in which lower molecular weight polymers or oligomers are prepared the method and use of the invention may further involve the addition of a chain transfer agent and a chain transfer agent may be included in the polymer precursor composition of the fifth aspect or the packaged polymer precursor product of the sixth aspect.

Chain transfer agents are also known as modifiers or regulators and can be added to a free radical polymerisation reaction to decrease the polymer chain length allowing the formation of oligomers and low molecular weight polymers.

Suitable chain transfer agents are known to the person skilled in the art and are typically halogen compounds, some aromatic hydrocarbons, alcohols and thiols (mercaptans). Suitable chain transfer agents for use herein include pentaphenylethane, iso propyl alcohol, carbon tetrachloride, carbon tetrabromide, n-butylmercaptan, 3-mercaptopropane-1,2-diol, 4-methylbenzenethiol and dodecanethiol,

Other suitable chain transfer agents include aldehydes, especially propanal.

The polymers prepared according to the present invention find utility in a variety of applications. For example polymers of the invention may be used in any photocurable polymer systems, including for example: adhesives, sealants, self healing polymers, paints, powder coatings, electronics (photoresists), nail varnish, curable inks, decorative effects, medical (medical gels, drug delivery), dental, packaging (e.g. food), and 3D printing.

The polymers provided by the present invention may be particularly useful as self healing polymers since the initiator salt may be activated by natural light at ambient temperature. Self healing polymers are known in the art and are described, for example in U.S. Pat. No. 10,508,204.

Self healing polymers may be useful in coating applications. Where a coating is scratched or otherwise damaged exposure to visible light may activate the initiator and allow the polymer to repair itself.

A further advantageous application of the present inventions is as a chaser catalyst.

Residual monomers present in a polymer product can be problematic because of their hazardous nature: many monomers demonstrate significant toxicity to human health. Reducing the residual monomer content of a polymeric product is therefore highly desirable to prevent workplace exposure and exposure to the consumer. Residual monomer removal techniques may involve chemical or physical methods. Chemical methods include the reaction of the residual monomer to generate additional polymer or to produce non-toxic or easily removable compounds. Physical methods include the removal of residual monomer from the polymer by evaporation, by solvent extraction or with the aid of an ion-exchange resin.

Commonly used chemical methods include increasing the reaction temperature and/or using a finishing catalyst, often referred to as a “chaser”. The activated free radical initiator comprising a salt of iron and ethylenediamine disuccinic acid of the third aspect of the present invention may be suitably used as a chaser catalyst.

A further useful application of the present invention is as a component of photocurable nail polish compositions. The components of such compositions will be known to the person skilled in the art.

The polymers provided by the present invention may be useful in oilfield applications.

In some embodiments the present invention may used to prepare polyacrylamide based polymers for use in hydraulic fracturing.

In some especially preferred embodiments the present invention is used to prepare polymers suitable for use in hydraulic fracturing by polymerising one or more monomers selected from cationic monomers, anionic monomers, non-ionic monomers and mixtures thereof.

Suitable cationic monomers include methacryloyloxyethyltrimethylammonium chloride, methacrylamidopropyltrimethylammonium chloride, acryloyloxyethyltrimethylammonium chloride, dimethyldiallylammonium chloride, 1,3-bis(N,N,N-trimethylammonium)-2-propylmethacrylate dichloride and 1,3-bis(N,N,N-trimethylammonium)-2-propylacrylate dichloride.

Suitable anionic monomers include sodium acrylate, sodium 2-acrylamido-2-methylpropane sulfonate; sodium vinyl sulfonate, sodium methacrylate, methyl methacrylate, 4-vinyl benzylsulfonate, 4-isopropenyl-benzoate and vinyl phosphonate.

Suitable non-ionic monomers include acrylamide, methacrylamide, N,N-dimethylacrylamide and vinyl pyrolidonone.

The polymer suitable for use in hydraulic fracturing is preferably derived from the aforementioned anionic monomers and non-anionic monomers.

Preferably said polymer includes acrylamide repeat units and acrylic acid repeat units.

Acrylic acid repeat units may be present in salt form, for example, as a sodium salt. In some embodiments up to 30 mol % or up to 50 mol % of the repeat units are acrylic acid repeat units. In preferred embodiments the acrylic acid repeat units are present in free acid form.

In some embodiments polymer suitable for use in hydraulic fracturing is prepared from one or more monomers including an anionic group, for example sulfonate moieties. Suitable such monomers include styrene sulfonate and 2-acrylamido-2-methylpropane sulfonic acid (AMPS).

In some embodiments the present invention may provide a polymer obtained from acrylamide and acrylate and/or AMPS-based monomers.

The polymer suitable for use in hydraulic fracturing may have a number average molecular weight of at least 200,000. Said number average molecular weight may be at least 500,000, preferably at least 1,000,000. The number average molecular weight may be less than 50,000,000 or less than 30,000,000. Molecular weight, described herein, may be measured by Measurement of Intrinsic Viscosity (see ISO 1628/1-1984-11-01); and using Intrinsic Viscosity/Molecular Weight Correlation via the Mark-Houwink Equation). Said molecular weight may be in the range 15,000,000 to 30,000,000.

Further features of polymers of this type are described in WO 2022/162348.

The invention will now be further described with reference to the following non-limiting examples.

In the examples any reference to Fe(III) EDDS relates to a composition (e.g. solution or solid) which comprises Fe³⁺ cations and EDDS anions. This does not necessarily mean that these ions are present in any particular stoichiometric amount. For example, as the skilled person will appreciate, other ions, such as sodium cations or chloride anions may also be present.

### Example 1

Ethylenediamine disuccinic acid (EDDS) (70 wt % in water, 8.34 g, 20 mmol) was slurried in water (20 g) at room temperature. Sodium hydroxide solution (50 wt %, 3.6 g) was added to raise the pH to 7. Iron (III) chloride solution (45 wt % in water, 7.2 g, 20 mmol) was added dropwise; simultaneously sodium hydroxide solution was added dropwise to maintain pH 7. The resulting slurry was heated to 80° C. for 2 hrs and a clear solution formed. The pH was adjusted to 4.0-4.5 and the reaction mass filtered to remove unwanted solids. The filtrate was a solution of Fe(III) EDDS ready for use in subsequent reactions.

### Example 2

Solid Fe(III) EDDS was prepared by oven drying of the solution obtained in Example 1 (45° C.).

### Example 3—Polymerisation of Methyl Methacrylate (MMA)

Methyl methacrylate (MMA) (1 g) and ethanol (4 mL) were charged to a glass vial. The required mass of Fe(III) EDDS was dissolved in de-ionised water (DIW) and charged, and then additional DIW was added such that the total charge of DIW was 4 mL. The vial was placed in natural light for 6 hrs, then the resultant slurry was stored in a fan oven (45° C.) for 16 hrs to remove water, ethanol and residual monomer. The yield was calculated by weighing the amount of dried poly(methyl methacrylate) (PMMA) produced and was expressed relative to the mass of MMA initially charged.

Table 1 shows the results obtained for a range of different Fe(III) EDDS charge weights.

TABLE 1

| | Mass of | Mass of Fe(III)EDDS | |
|---|---|---|---|
| | Fe(III)EDDS | relative to MMA | Yield of |
| Experiment | (mg) | charge (wt %) | PMMA (%) |
| 1 | 400 | 40 | 5 |
| 2 | 200 | 20 | 20 |
| 3 | 100 | 10 | 20 |
| 4 | 50 | 5 | 30 |
| 5 | 25 | 2.5 | 50 |
| 6 | 10 | 1 | 50 |
| 7 | 5 | 0.5 | 90 |
| 8 | 2.5 | 0.25 | 90 |
| 9 | 1 | 0.1 | 90 |
| 10 | 0.5 | 0.05 | 80 |
| 11 | 0.25 | 0.025 | 50 |

These results show that Fe(III) EDDS was an effective photoinitiator for the polymerisation of MMA, even when used at low concentrations (such as 0.25 wt % relative to the monomer charge).

### Example 4—Polymerisation of Acrylic Acid (AA)

An experiment was carried out in analogous manner to Example 3 but using acrylic acid (AA) (0.22 g) instead of MMA and a total DIW charge of 2 mL. Ethanol was not used. The vials were then placed in natural light for two weeks, then dried as for Example 3 to provide poly(acrylic acid) (PAA).

Table 2 shows the results obtained for a range of different Fe(III) EDDS concentrations, relative to AA.

TABLE 2

| | Mass of | Mass of Fe(III)EDDS | |
|---|---|---|---|
| | Fe(III)EDDS | relative to monomer | Yield of |
| Experiment | (mg) | charge (wt %) | PAA (%) |
| 1 | 0.55 | 0.25 | 98 |
| 2 | 0.22 | 0.1 | 100 |
| 3 | 0.055 | 0.025 | 99 |
| 4 | 0.022 | 0.01 | 73 |
| 5 | 0.017 | 0.0075 | 77 |
| 6 | 0.011 | 0.005 | 77 |
| 7 | 0.006 | 0.0025 | 68 |

These results show that Fe(III) EDDS was an effective photoinitiator for the polymerisation of AA.

The isolated poly(acrylic acid) products of Example 4 were analysed by size exclusion chromatography (SEC) relative to poly(ethylene glycol) standards.

In this method an Agilent 1260 Infinity Il machine was fitted with a triple detector, using a PL aquagel-OH MIXED-H 8 μm (300×7.5 mm) column and a PL aquagel-OH 30 8 μm (300×7.5 mm) column in series. The column temperature was 30° C., the flow rate 1 ml per minute, and the eluent water/sodium azide.

The results are shown in Table 3.

TABLE 3

| | GPC analysis | | |
|---|---|---|---|
| Experiment | Mn | Mw | PDI |
| 1 | 119,000 | 131,500 | 2.2 |
| 2 | 123,675 | 255,043 | 2.1 |
| 3 | 131,000 | 250,000 | 2.0 |
| 4 | 144,000 | 280,000 | 1.9 |
| 5 | 145,000 | 280,000 | 1.9 |
| 6 | 161,000 | 343,000 | 2.1 |
| 7 | 165,000 | 400,800 | 2.4 |

These results show that when Fe(III) EDDS was used as photoinitiator, high molecular weight (Mn) PAA could readily be produced.

### Example 5—Polymerisation of Styrene

Styrene (0.22 g) was charged to a glass vial, followed by Fe(III) EDDS (0.02 wt % solution in water, 0.278 mL, 0.56 mg). Ethanol (0.9 mL) was added and then the overall reaction volume was adjusted to 2 mL using DIW. The vial was placed in natural light for 1 week; polymer began to appear after 24 hrs. After 1 week the reaction mass was dried as for Example 3. Polystyrene (56% yield, relative to the initial charge of styrene) was obtained as a white solid.

### Example 6—Polymerisation of poly(ethylene glycol)methyl ether methacrylate

Example 5 was repeated, but replacing styrene with poly(ethylene glycol) methyl ether methacrylate (average Mn ~350). The reaction time (in natural light) was extended to 2 weeks. After drying in identical manner to Example 3, the polymer of poly(ethylene glycol) methyl ether methacrylate (77% yield, relative to the initial charge of monomer) was obtained.

### Example 7—Polymerisation of [2-(Methacryloyloxy)ethyl]dimethyl-(3-sulfopropyl)ammonium hydroxide (DMAPS)

A vial containing a solution of DMAPS (1 g) and Fe(III) EDDS (0.01 g) in water (8 mL total) was placed in natural light for 24 hrs. An aliquot of the reaction mixture was taken and analysed by SEC against poly(ethylene glycol) standards. The polymer was obtained in 85% yield. Molecular weight data is shown in Table 4.

TABLE 4

| | |
|---|---|
| Mn | 1,997,000 |
| Mw | 3,852,000 |
| PDI | 1.9 |

### Example 8

0.1 g Fe(III) EDDS was dissolved in 9.9 g de-ionised water to provide a 1 wt % solution.

A polymer precursor composition containing 30 g de-ionised water, 30 g ethanol and 10 g methyl methacrylate was prepared.

The 1 wt % Fe(III) EDDS solution was irradiated for 10 minutes under a UV lamp (15 W lamp at 302 nm). The resultant composition was then stored under dark conditions.

After the time period specified in table 5, 1 g of the irradiated 1 wt % Fe(III) EDDS solution was mixed with 7 g of the polymer precursor composition. This resultant mixture was stored in the dark under ambient conditions and the appearance monitored until the extent of polymerisation was such that the sample had solidification. A control experiment was carried out with non-irradiated Fe(III) EDDS.

TABLE 5

| Time between | |
|---|---|
| irradiation and | |
| contact with | |
| polymer precursor | Time of solidification |
| (hr) | after mixing (days) |
| 0 | 2 |
| 0.25 | 11 |
| 0.5 | 12 |
| 2 | 15 |
| 24 | 20 |

The non irradiated sample did not polymerise over a three-week period.

The results show that a sample of irradiated Fe(III) EDDS can polymerise a solution of methyl methacrylate even after dark storage for 24 hours after irradiation.

### Example 9

A polymer precursor composition was prepared by admixing 100 g methyl methacrylate, 300 g water and 300 g water.

1 g Fe(III) EDDS was dissolved in 99 g de-ionised water to give a 1 wt % solution.

The 1 wt % Fe(III) EDDS solution was irradiated for 20 minutes under a UV lamp (15 W at 302 nm) and added to the polymer precursor composition. The resultant composition was stirred and then stored in the dark. After 3 weeks the polymerisation had occurred. The mass of PMMA produced was 96.7 g.

### Example 10

A composition was prepared by admixing 10 g methyl methacrylate, 40 g ethanol, 2 g Fe(III) EDDS and 40 g de-ionised water in a measuring cylinder. The cylinder was exposed to natural light for 48 hr. A film of polymethyl methacrylate (PMMA) formed on the inner wall, leaving unexposed reaction solution in the middle of cylinder.

In order to demonstrate self-repair, a strip of polymer was scraped away from the cylinder inner surface and removed. The cylinder was exposed for a further 48 hr to natural light after which time the area where the PMMA was removed had been replaced by new polymerised material.

1. The use of a salt of iron and ethylenediamine disuccinic acid as a free radical initiator in the free radical polymerisation reaction of one or more monomers.

2. A method of preparing a polymer, the method comprising contacting one or more monomers with a radical species derived from a salt of iron and ethylenediamine disuccinic acid.

3. The method according to claim 2 which involves the steps of:
(a) preparing a composition comprising one or more monomers and a salt of iron and ethylenediamine disuccinic acid; and
(b) exposing the composition provided in step (a) to actinic radiation.

4. The method according to claim 2 which involves the steps of:
(i) providing a composition comprising a salt of iron and ethylenediamine disuccinic acid;
(ii) exposing the composition comprising the salt of iron and ethylenediamine disuccinic acid to actinic radiation to provide an activated free radical initiator composition;
(iii) optionally storing the activated free radical initiator composition provided in step (ii); and
(iv) contacting the activated free radical initiator composition with one or more monomers.

5. A polymer precursor composition comprising one or more monomers and a salt of iron and ethylenediamine disuccinic acid.

6. A packaged polymer precursor product comprising within a container a composition comprising one or more monomers and a salt of iron and ethylenediamine disuccinic acid; wherein the container does not transmit UV or visible light having a wavelength of 100 to 400 nm.

7. A polymer obtained by the free radical polymerisation of one or more monomers in a reaction initiated by a salt of iron and ethylenediamine disuccinic acid.

8. An activated free radical initiator comprising a salt of iron and ethylenediamine disuccinic acid.

9. A packaged comprising within a container an activated free radical initiator comprising a salt of iron and ethylenediamine disuccinic acid; wherein the container does not transmit UV or visible light having a wavelength of 260 to 390 nm.

10. A polymer obtained by the method of claim 2.

11. The method according to claim 2, wherein the salt of iron and ethylenediamine disuccinic acid is of the formula FeXEDDS wherein X is a hydrogen, metal, ammonium or substituted ammonium cation.

12. The method according to claim 2, wherein the one or more monomers are selected from (meth)acrylates, alkenes, conjugated dienes, styrenes, alkyl and halo-styrenes (e.g. α-methylstyrene), divinylbenzene, acrolein, vinyl acetate, vinylpyrrolidone, vinylimidazole, maleic anhydride, fumaric anhydride, (meth)acrylic acid and (meth)acrylic acid derivatives, for example esters and amides, vinyl halides and vinylidene halides.

13. The method according to claim 2, wherein the one or more monomers are selected from acrylates, methacrylates and styrene derivatives.

14. The method according to claim 2, wherein the salt of iron and ethylenediamine disuccinic acid is provided in an amount of from 0.001 to 10 wt % based on the total weight of the one or more monomers.

15. The method according to claim 2 which provides a polymer having a number average molecular weight in excess of 4000.

16. The method according to claim 2, which provides a polymer having a number average molecular weight in excess of 600,000.

17. The use of a polymer according to claim 6 in one or more of adhesives, sealants, self healing polymers, paints, powder coatings, electronics (photoresists), nail varnish, curable inks, decorative effects, medical (medical gels, drug delivery), dental, packaging (e.g. food), and 3D printing applications.

18. The use of a polymer according to claim 6 as a chaser catalyst.

19. The method according to claim 2, which provides polyacrylamide based polymers suitable for use in hydraulic fracturing.

20. The method according to claim 19, wherein the one or more monomers include acrylamide and acrylic acid and/or AMPS-based monomers.

21. A polymer obtained by the method of claim 19.
